(19) United States
(12) Patent Application Publication
(10) Pub. No.: US 2009/0203317 A1
(43) Pub. Date: Aug. 13, 2009

(54) METHOD AND APPARATUS FOR EVENT CONFIRMATION USING PERSONAL AREA NETWORK

(75) Inventor: William Yih Yuan Waung, Burnaby (CA)

Correspondence Address: Nixon Peabody LLP, 200 Page Mill Road, Palo Alto, CA, 94306, US

(73) Assignee: Sierra Wireless Inc., a Canada Corporation

(21) Appl. No.: 12/426,949

(22) Filed: Apr. 20, 2009

Related U.S. Application Data
(62) Division of application No. 11/473,925, filed on Jun. 23, 2006.

(51) Int. Cl. H04B 7/00

(52) U.S. Cl. 455/41.2

(57) ABSTRACT

A method and a system for confirming an event using a short-range wireless communications network are disclosed. The mechanism includes various steps including monitoring the event, verifying the event, and performing a function when the event is verified. In one embodiment, a series of events are initially entered in a scheduling database such as a calendar software. Once the events are stored in the scheduling database, the mechanism monitors the events in accordance with a predefined sequence. In one aspect, the events may be ordered in a chronological order. If an occurrence of the event according to a predefined sequence is detected, the mechanism obtains ambient information using its short-range wireless capability to verify the actual occurrence of the event. Upon verifying the occurrence of the event, the mechanism performs a function, which can be a predetermined function or a real-time instructed function.

### CROSS-REFERENCE TO RELATED PATENT APPLICATION

The present application is a divisional of U.S. patent application Ser. No. 11/473,925, filed Jun. 23, 2006.

### FIELD OF THE INVENTION

The present invention relates to communications network. More specifically, the present invention relates to wireless communication.

### BACKGROUND OF THE INVENTION

With increasing popularity of adopting time management using calendar software, conferences, business meetings and social activities are commonly being arranged and managed using such calendar programs such as Microsoft Outlook™. The contact software, for example, is able to combine multiple meeting coordination functions such as electronic mail and calendar management into one simple operation. For instance, a user can schedule a meeting by sending an email inviting various intended meeting attendees in a single operation. Any subsequent acceptance or rejection emails from the intended meeting attendees can typically be used to update the attendance roster of the meeting automatically.

More recently, the capability of contact software, which used to exist on desktop computers, is being incorporated into portable devices such as Personal Digital Assistants (“PDAs”) and SmartPhones. Some of the PDAs also incorporate cellular telephony functionalities. As such, a PDA or SmartPhone user can be reminded of any upcoming meetings regardless of his or her whereabouts. In other words, a user no longer needs to be at the desktop computer to be reminded of any upcoming meetings.

Some PDAs and SmartPhones having calendar program are also capable of adjusting notification settings of PDAs such as settings for various ring tones. If a time period on a calendar is marked for a meeting, for example, the PDAs may reset its notification settings (ring tone) to silent mode. However, a problem associated with this method is that it does not take into account the possibility that the user has forgotten the meeting. This type of automatic setting may result in the user not being aware of temporary suspension of notification for all incoming calls. It could be a call from the other meeting attendees requesting user's attendance.

In view of the foregoing, it is desirable to have a confirmation mechanism that verifies an event before a function or functions to be performed.

### SUMMARY OF THE INVENTION

A mechanism for confirming an event using short-range wireless communications network is disclosed. The mechanism includes various steps including monitoring the event, verifying the event, and performing a function when the event is verified. In one embodiment, a series of events are initially entered in a scheduling database such as a calendar software. Once the events are stored in the scheduling database, the mechanism monitors the events in accordance with a predefined sequence. In one aspect, the events may be ordered in a chronological order. If an occurrence of the event according to a predefined sequence is detected, the mechanism obtains ambient information using its short-range wireless capability to verify the actual occurrence of the event. Upon verifying the occurrence of the event, the mechanism performs a function, which can be a predetermined function or a real-time instructed function.

Additional features and benefits of the present invention will become apparent from the detailed description, figures and claims set forth below.

### BRIEF DESCRIPTION OF THE DRAWINGS

The present invention will be understood more fully from the detailed description given below and from the accompanying drawings of various embodiments of the invention, which, however, should not be taken to limit the invention to the specific embodiments, but are for explanation and understanding only.

FIG. 1 illustrates a wireless communication system for event confirmation in accordance with one embodiment of the present invention;

FIG. 2 is a flowchart illustrating a process of event confirmation using a short range wireless communications network in accordance with one embodiment of the present invention; and

FIG. 3 illustrates a digital processing device in accordance with one embodiment of the present invention.

### DETAILED DESCRIPTION

A method and device for confirming an event using a short-range wireless communications network are disclosed.

Those of ordinary skill in the art will realize that the following detailed description of the present invention is illustrative only and is not intended to be in any way limiting. Other embodiments of the present invention will readily suggest themselves to such skilled persons having the benefit of this disclosure. It will be apparent to one skilled in the art that these specific details may not be required to practice to present invention. In other instances, well-known circuits and devices are shown in block diagram form to avoid obscuring the present invention. In the following description of the embodiments, substantially the same parts are denoted by the same reference numerals.

In the interest of clarity, not all of the features of the implementations described herein are shown and described. It will, of course, be appreciated that in the development of any such actual implementation, numerous implementation-specific devices must be made in order to achieve the developer's specific goals, wherein these specific goals will vary from one implementation to another and from one developer to another. Moreover, it will be appreciated that such a development effort might be complex and time-consuming, but would nevertheless be a routine undertaking of engineering for those of ordinary skill in the art having the benefit of this disclosure.

In accordance with the present invention, the components, process steps, and/or data structures may be implemented using various types of operating systems, computing platforms, computer programs, and/or general purpose machines. In addition, those of ordinary skill in the art will recognize that devices of a less general purpose nature, such as hardwired devices, field programmable gate arrays (FPGAs), application specific integrated circuits (ASICs), or the like, may also be used without departing from the scope and spirit of the inventive concepts disclosed herein.

It is understood that the present invention may contain transistor circuits, chip packaging, and circuit board technology that are readily manufacturable using well-known art, such as for example CMOS (“complementary metal-oxide semiconductor”) technology, or other semiconductor manufacturing processes. In addition, the present invention may be implemented with other manufacturing processes for making digital devices.

While particular embodiments of the present invention have been shown and described, it will now be apparent to those skilled in the art having the benefit of this disclosure that many more modifications than mentioned above are possible without departing from the inventive concepts disclosed herein. Therefore, the appended claims are intended to encompass within their scope all such modifications as are within the spirit and scope of this invention.

The present invention discloses a mechanism of performing a function according to a verified event confirmation using a short-range wireless communications network. The mechanism includes various steps including monitoring the event, verifying the event with the ambient environment, and performing a function when the event is verified. In one embodiment, a series of events are initially entered in a scheduling database such as a calendar software. Once the events are stored in the scheduling database, the mechanism monitors the events in accordance with a predefined sequence. In one aspect, the predefined sequence is a chronological sequence and thus, the events may be ordered in accordance with chronological order. If an occurrence of the event according to a predefined sequence is detected, the mechanism obtains ambient information relating to the event using its short-range wireless capability to verify the actual occurrence of the event. Upon verifying the occurrence of the event, the mechanism performs a function, which can be a predetermined function or a real-time instructed function.

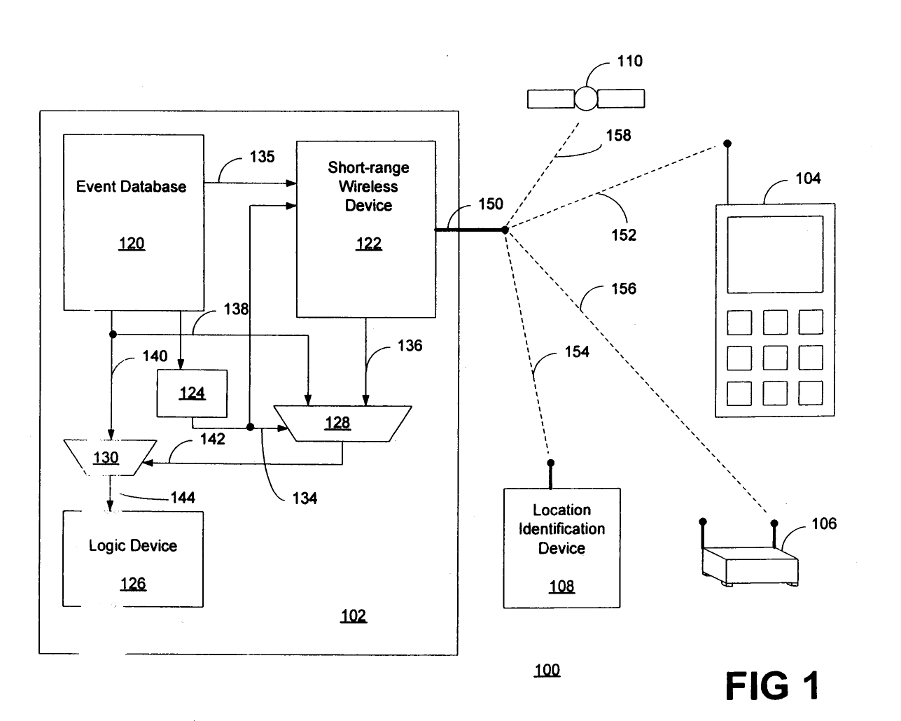

FIG. 1 is a block diagram illustrating a wireless communication system 100 for event confirmation in accordance with one embodiment of the present invention. System 100 includes a handheld device 102, a wireless device 104, a wireless local area network (“WLAN”) device 106, a location identification device 108, and a satellite 110. Various wireless medium 152-158 are used to interconnect between the devices 102-110. In one embodiment, wireless device 104 is substantially the same device as handheld device 102.

Referring back to FIG. 1, handheld device 102 further includes an event database 120, a short-range wireless device 122, a monitor 124, and a logic device 126. Event database 120 is capable of storing data and/or information relating to various events including meeting time, meeting locations, meeting rosters and attendees' email lists for every event. In addition to storing a series of events, event database 120 also stores confirmation data relating to stored events. In one embodiment, the confirmation data includes ambient data and expected environment for each event. Ambient data, which is also known as ambient information, ambient environment data, surrounding data, indicates what data should be collected in the vicinity environment in relation to the event. The data collected from the vicinity environment, hereinafter referred to the collected ambient data, is the necessary environmental data to verify the occurrence of the event. In one embodiment, the confirmation data also includes information about how to establish a short-range wireless communications network and how to collect the data from the immediate environment using the short-range wireless communications network. The expected environment is the information or data expected from the surrounding environment if the event is actually taking place. The expected environment is used to compare with collected ambient data to verify the occurrence of the event. In one embodiment, the ambient data and expected environment are substantially the same data.

Information relating to the events and confirmation data, in one embodiment, is initially loaded into event database 120. For example, the events and confirmation data can be loaded manually by a user or by a system. A laptop computer, for example, may directly store a sequence of events into a calendar database in event database 120 via a cable or a wireless connection. Also, an event and its confirmation data may be loaded or entered by a meeting notice. For instance, a meeting notice from a Microsoft Outlook™, which contains a meeting time, a meeting roster as well as a meeting location, can be sent according to the meeting roster. When a meeting notice is accepted by the user, the meeting event, attendees' list, and meeting location are automatically stored in event database 120. It should be noted that event database 120 may include several components such as, for example, an event memory, a confirmation data memory, a microcontroller, flash memory, bus controller, and so forth.

Monitor 124, which can be an executable subroutine or a hardware component depending on the design preference, monitors the occurrence of a scheduled event according to a predefined sequence. For example, monitor 124 checks the scheduled events stored in the calendar and it issues a detection signal when an event has occurred or is about to occur according to the calendar. While bus 132 facilitates data transfer between monitor 124 and event database 120, bus 134 provides control signals to short-range wireless device 122 and/or comparison device 128 in response to the detection of an event. It should be noted that monitor 124 can transmit event related data to short-range wireless device 122 and/or comparison device 124.

Short-range wireless device 122 is capable of establishing a short-range wireless communications network such as a personal area network (“PAN”), a WLAN or other types of short-range wireless communication networks. PAN includes, but not limited to, Bluetooth, Ultra Wideband, ZigBee, or Ambient networks. Short-range wireless device 122 obtains event information and the confirmation data from event database 120 or from monitor 124. Once a PAN is established, Short-range wireless device 122 uses various medium 152-154 to communicate with nearby wireless devices such as wireless device 104 and location identification device 108. In another embodiment, short-range wireless device 122 sets up a WLAN protocol media 156 between handheld device 102 and WLAN device 106 for obtaining data from the vicinity environment. When the collected ambient data is received via antenna 150 of short-range wireless device 122, it is subsequently forwarded to comparison device 128 for verification. The collected ambient data, for example, may include surrounding environment such as number of attendees in the meeting room.

In another embodiment, instead of having a short-range wireless device 122, the present invention employs a wireless device using the global positioning system (“GPS”). GPS is a worldwide radio-navigation system that is widely used in marine, terrestrial navigation and location based services. GPS also refers to satellite-based radio positioning systems that provide location, speed and time information. In one embodiment, handheld device 102 uses a GPS device to establish a wireless media 158 to obtain information such as current localities, time and speed from satellite 110. It should be noted that any other types of wireless communication devices may be used for obtaining the ambient data.

Comparison device 128 compares the collected ambient data against expected environment in accordance with the event. Comparison device 128 receives expected environment from event database 120 via bus 138 and the collected ambient data from short-range wireless device 122 via bus 136. The result of the comparison is subsequently fed to gate or multiplexer 130 via bus 142. If the collected ambient data verifies with the expected environment, gate 130 passes the event related data from event database 120 via bus 140 to logic device 126 via bus 144. On the other hand, if the collected ambient data fails to verify with the expected environment, which indicates that the event has not actually happened yet, gate 130 prevents the information related to event to pass from event database 120 to logic device 126. As such, if gate 130 is logically off, which means no data passing through gate 130, logic device 126 will not perform any functions. Logic device 126 is activated or deactivated depending on the result of comparison between the collected ambient data and the ambient environment. In another embodiment, if the collected ambient data fails to verify with the expected environment, comparison device 128 issues an event delay signal to indicate that the event has not yet occurred yet.

Logic device 126, in one embodiment, performs a predefined function(s) according to a verified event. For example, logic device 126 may turn off the ring tone if the current meeting is verified. Also, logic device 126 turns on a beep to remind the user that the train he or she is riding is approaching to a destination station. Logic device 126 can suspend or limit incoming phone calls except calls from family members when the user is on vacation. In another embodiment, logic device 126 performs a function according to a real-time instruction, which may be obtained through one or more wireless communication networks. The information about predefined functions and/or how to obtain the real-time instructed function is stored in event database 120. In another embodiment, logic device 126 performs a predetermined function, if it receives an event delay signal. For example, upon receipt of an event delay signal, logic device 126 may instruct short-range wireless device 122 to continue checking the status of the event. In another example, logic device 126 may send a canceling/rescheduling meeting notice to the roster listed in the event after receipt of an event delay signal.

Handheld device 102 is capable of performing a function or a series of functions in response to a verified event. A short-range wireless communications network or PAN is used to obtain the collected ambient data for verification. Handheld device 102 has many event confirmation applications. For example, instead of setting the phone notification method based on calendar information alone, system 100 allows the exchange of information between the phone and the nearby devices via a short-range wireless communications network to assess and verify the environmental conditions.

System 100 has many applications, especially in the area of PDAs and/or SmartPhones. It should be noted that current PDAs and SmartPhones are increasingly incorporating various Personal Area Network (PAN) technologies such as Bluetooth and Ultra Wideband. When handheld device 102 such as a PDA or a SmartPhone determines that a meeting is scheduled for the current time, it uses a PAN to obtain (or interrogate or probing inquiries) data from the immediate environment. A standardized protocol allows handheld device 102 to determine whether there are other compatible wireless devices in the immediate vicinity. If there are such devices, handheld device 102 can verify whether these devices are associated with the expected meeting attendees. This verification process, for example, can be achieved through exchange of email addresses between handheld device 102 and the compatible wireless devices, which are then matched against the email addresses of those who accepted the meeting invitation. If a number of the intended attendees are found to be in the vicinity, handheld device 102 can more confidently assume that the user is in the scheduled meeting, and then sets the ring notification of handheld device 102 to silent mode.

If a meeting room equips wireless location identification devices 108, the meeting room can respond directly to various PAN probing inquiries. When handheld device 102 determines that it is in the scheduled meeting room, it can assume that the user is in the scheduled meeting.

System 100 can also be useful beyond business meetings. For example, if the calendar entry indicates an attendance of a musical performance or a movie, and the theater, which is equipped with a wireless location identification device, identifies itself via a PAN, handheld device 102 picks up the identification of the theater and automatically sets the notification setting to non-audible ring notification, or disables the incoming calls altogether. If, however, the user misses the movie, handheld device 102 would not receive the confirmation of location identification from the theater and consequently, ring indication of handheld device 102 would not be changed.

Handheld device 102, which could be a PDA or a SmartPhone, is also capable of using a WLAN to influence settings on handheld device 102. For example, if handheld device 102 senses the WLAN associated with the user's home and there is no meeting or teleconference scheduled on the calendar application, handheld device 102 changes its setting to filter incoming calls based on user's preferences. For instance, only calls from a selected group of individuals are allowed to pass and all other calls from the company's “Global Address List” are diverted to voice mail.

Handheld device 102 may also detect a PAN device or location identification device 108 indicating location within a movie theater or concert hall. If no meeting has been scheduled, handheld device 102 may assume the user is participating in a leisure activity and activates non-audible ring notification for the handheld device 102. In addition, handheld device 102 may also filter incoming calls based on user's preferences as described above.

Handheld device 102, which could be a PDA, may also use information regarding geographic locations to adjust ring notification or to filter incoming call. For example, if handheld device 102 receives geographic data (e.g. GPS, location beacons, cell identifiers, etc.) indicating its location within an area designated to leisure activities such as a city park or a golf course, handheld device 102 may perform certain functions such as filtering incoming calls except calls from family numbers.

Handheld device 102 may also use a PAN to determine whether the user is with a group of pre-selected individuals and if it is, some settings of handheld device 102 need to be altered. For example, if handheld device 102 discovers through the PAN that it is within close proximity to a group of individuals designated as “good golfing buddies”, then call screening and/or non-audible ring may be activated.

The present invention includes various processing steps, which will be described below. The steps of the present invention may be embodied in machine or computer executable instructions. The instructions can be used to cause a general purpose or special purpose system, which is programmed with the instructions to perform the steps of the present invention. Alternatively, the steps of the present invention may be performed by specific hardware components that contain hard-wired logic for performing the steps, or by any combination of programmed computer components and custom hardware components. While embodiments of the present invention will be described with reference to wireless communications network, the method and apparatus described herein is equally applicable to other network infrastructures or other data communications environments.

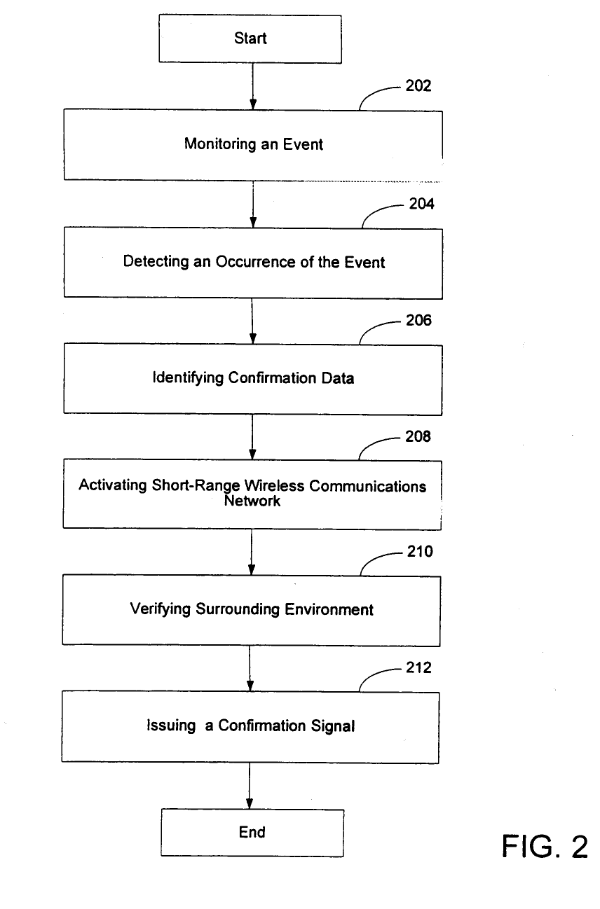

FIG. 2 is a flowchart illustrating a process for performing a function in response to a verified event using a short-range wireless communications network in accordance with one embodiment of the present invention. At block 202, the process monitors a predefined event in accordance with a predefined sequence such as an electronic calendar or calendar software. For example, the events are organized in an executable sequential order. For another example, the events are organized in a chronological order within a calendar software. The process reads the data stored in the calendar and raises a detecting signal when it finds an event according to the calendar. In one embodiment, the series of events, the predefined sequence and the confirmation data relating to each event are entered in an event database, which can be any types of storage medium. After block 202, the process proceeds to the next block.

At block 204, the process detects an occurrence of the event according to a calendar or a predefined sequence. In one embodiment, the process is capable of identifying a scheduled meeting, a specific geographic location, a predefined situation, or a predefined ambient environment from processing the calendar software or any other types of predefined sequence. Once an event is detected, the process proceeds to the next block.

At block 206, the process identifies confirmation data in response to the detected event. The confirmation data further includes information relating to expected environment and information relating to event environment, which will be used by the short-range wireless device to collect ambient data for verification. After the confirmation data is identified, the process moves from block 206 to block 208.

At block 208, the process activates a short-range wireless communications network to collect the ambient data or surrounding data in response to the confirmation data. The process establishes a PAN or a WLAN or both to obtain information regarding ambient data. In one embodiment, the process also establishes a GPS connection to a satellite to obtain ambient data about localities and/or distances. In operation, the process initially tries to locate any nearby wireless devices such as a PDA, a SmartPhone, and/or a location identification device. After a nearby wireless device(s) is identified, the process obtains information according to the confirmation data from the identified nearby wireless devices via its short-range wireless capabilities. Once the collected ambient data is obtained, the process moves to the next block. It should be noted that during the process of setting up a short-range wireless communications network, a security channel may also be established before a PAN or WLAN is established.

At block 210, the process verifies the surrounding data in accordance with the event. In one embodiment, the process compares the collected ambient data (collected by the short-range wireless device) with the expected environment. If the collected ambient data verifies with the expected environment, the process declares a verified occurrence of the event or a confirmation signal indicating the event is taken place. To declare a verified occurrence of an event or a verified event, the collected ambient data does not have to match exactly with the expected environment. Various intelligent comparison techniques may be employed to determine whether a match or substantially match between the collected ambient data and the ambient environment is made. Once a verified occurrence of the event is identified, the process moves from block 210 to block 212.

At block 212, the process issues a confirmation signal after the surrounding data verifies with the event. In one embodiment, the process performs a predefined function in response to the confirmation signal. For example, a handheld device or a PDA adjusts its ring setting to a predefined setting when a meeting event is actually taking place. After receipt of the confirmation signal, the process, in another embodiment, performs a function according to a real-time instruction sent by a remote device over a wireless communication network. After block 212, the process ends.

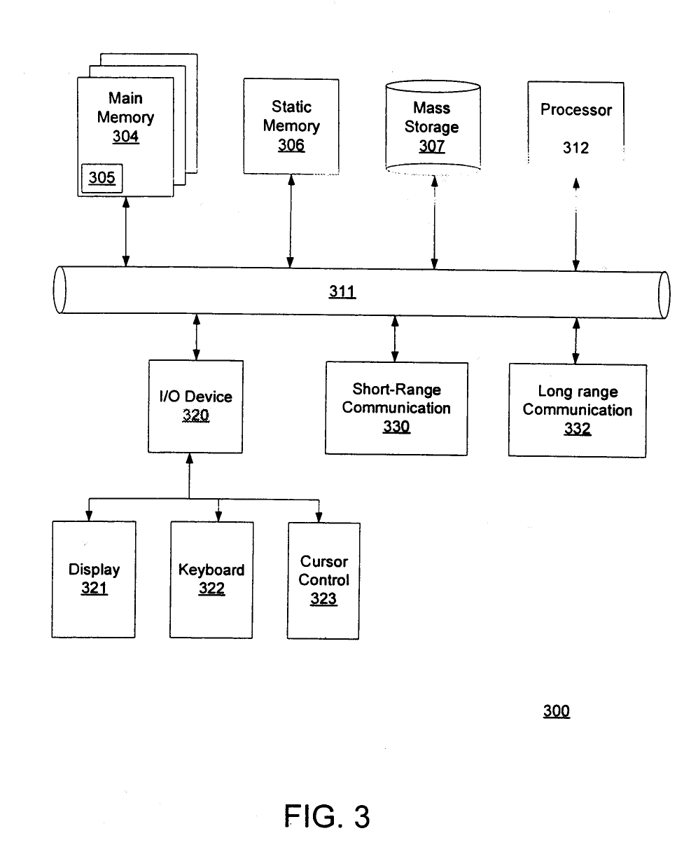

FIG. 3 illustrates a digital processing system 300, which could be incorporated into handheld device 102, in accordance with one embodiment of the present invention. System 300 includes an input/output (“IO”) unit 320, a processor 312, a main memory 304, a system bus 311, a static memory device 306, a mass storage memory 307, a short-range communication device 330 and a long range communication device 332 (or modem). Bus 311 is used to transmit information between various components and processor 312 for data processing. Processor 312 may be any of a wide variety of general-purpose processors or microprocessors such as Pentium™ microprocessor, or Power PC™ microprocessor.

Main memory 304, which may include multiple levels of cache memories, stores frequently used data and instructions. Main memory 304 may be RAM (random access memory), MRAM (magnetic RAM), or flash memory. In one embodiment, main memory 304 contains event database 305. Static memory 306 may be a ROM (read-only memory), which is coupled to bus 311, for storing static information and/or instructions. Mass storage memory 307, which may be a magnetic disk, an optical disk, hard disk drive, floppy disk, CD-ROM, and/or flash memories for storing large amounts of data. I/O unit 320, in one embodiment, includes a display 321, keyboard 322, and cursor control device 323. Display device 321 may be a liquid crystal device or touch-screen display, or other suitable display device. Keyboard or keypad 322 may be a conventional alphanumeric input device for communicating information between system 300 and the user. Another type of user input device is cursor control device 323 for communicating information between system 100 and user(s).

Long range communication device 332 is coupled to bus 311 for accessing information from remote computers or servers through wide-area network. Long range communication device 332 may include a modern or a network interface device, or other similar devices that facilitate communication between computer and a network. Short-range communication device 330 is coupled to bus 311 for facilitating and establishing a short-range wireless communication network such as a PAN or WLAN.

While particular embodiments of the present invention have been shown and described, it will be obvious to those skilled in the art that, based upon the teachings herein, changes and modifications may be made without departing from this invention and its broader aspects. Therefore, the appended claims are intended to encompass within their scope all such changes and modifications as are within the true spirit and scope of this invention.

What is claimed is:

1. A method for automatically adjusting a setting of a device according to an occurrence of a meeting comprising:
monitoring an occurrence of a meeting in accordance with a chronological order in an electronic calendar;
identifying confirmation data stored in an event database in response to the meeting;
activating a personal area network (“PAN”) to collect ambient information relating to the meeting in response to the confirmation data;
verifying the occurrence of the meeting in response to comparison between collected ambient data and expected ambient environment; and
adjusting notification settings of the device when the occurrence of the meeting is confirmed.

2. The method of claim 1, wherein activating a PAN further includes:
locating a nearby device that also has wireless capability through PAN; obtaining an email identification from the nearby device; and
comparing the email identification from the nearby device with email identifications listed in stored meeting notice.

3. The method of claim 1, wherein activating a PAN further includes:
locating a location identification device utilizing the PAN;
obtaining a location identity from the location identification device through the PAN;
comparing the location identity with meeting room listed in a meeting notice; and
issuing a signal of a verified event when the location identity matches with the meeting room.
